(19) United States
(12) Patent Application Publication
(10) Pub. No.: US 2026/0065895 A1
(43) Pub. Date: Mar. 5, 2026

(54) AUDIO DATASET GENERATION TO SPECIFIC AUDIO DOMAIN USING TEXT-CONDITIONAL GENERATIVE MODELS

(71) Applicant: NEC Laboratories America, Inc., Princeton, NJ (US)

(72) Inventors: Wataru KOHNO, Princeton, NJ (US); Jian FANG, Princeton, NJ (US); Shaobo HAN, Princeton, NJ (US); Ting WANG, West Windsor, NJ (US); Jungchen SUN, Buffalo, NY (US)

(73) Assignee: NEC Laboratories America, Inc., Princeton, NJ (US)

(21) Appl. No.: 19/317,141

(22) Filed: Sep. 3, 2025

Related U.S. Application Data
(60) Provisional application No. 63/689,906, filed on Sep. 3, 2024.
(60) Provisional application No. 63/691,382, filed on Sep. 6, 2024.

(51) Int. Cl. G10L 13/08; G10L 13/04; G10L 25/60

(52) U.S. Cl. CPC G10L 13/08; G10L 13/04; G10L 25/60

(57) ABSTRACT

Two-stage domain-specific signal generation schemes using a text-conditional a generative audio model. The first stage includes an Event-classification simulator with language-audio models (e.g., CLAP models), which advantageously prevents the text-conditional generative model from generating incorrect data. The second stage incorporates a Domain shifter, which performs impulse-response convolution and background noise in addition to synthesized data, emulating unique sensing signals fiber optic sensing deployments, such as those from DAS. Advantageously, our inventive schemes can generate various synthesized data belonging to unique domains and store them as a special dataset. In terms of physical effort, our techniques only need record one impulse response and one background noise, significantly reducing data collection burden and costs typically associated with fine-tuning models. Of further advantage, our inventive schemes can be applied to other unique audio devices (e.g., laser microphones) or unique environments (e.g., underwater).

### CROSS REFERENCE TO RELATED APPLICATIONS

This application claims the benefit of U.S. Provisional Patent Application Ser. No. 63/689,906 filed Sep. 3, 2024, and U.S. Provisional Patent Application Ser. No. 63/691,382 filed Sep. 6, 2024, the entire contents of which is incorporated by reference as if set forth at length herein.

### FIELD OF THE INVENTION

This application relates generally to environmental monitoring using distributed fiber optic sensing (DFOS) technologies. More particularly, it pertains the to the application of large-scale audio pretrained models to distributed acoustic sensing (DAS) and especially audio dataset generation to specific audio domain using text-conditional generative models.

### BACKGROUND OF THE INVENTION

Distributed Acoustic Sensing (DAS) is a DFOS technology that uses fiber optic cables to detect acoustic vibrations. It has a wide range of applications due to its unique capabilities. Its ability to detect small vibrations over long distances in real-time makes it a valuable tool for monitoring and protecting the environment.

Applications for DAS include traffic monitoring, power-cable monitoring, seismic monitoring, anomaly detection, and underwater surveillance. With hardware advancements, DAS is now being explored for weaker airborne acoustic-signal detection, including voice and drone detection.

From a user perspective, a key to monitor environments around the sensors is understanding the events with time and location information. DAS can localize signals along the fiber, providing preliminary insights into the event's origin and dynamics. It is also crucial to interpret data from numerous sensors across different environments using advanced spatial-temporal pattern recognition methods. These methods analyze and identify significant patterns and anomalies, requiring robust and accurate models built from extensive data recorded in actual deployment environments. Specific models must be developed to process this data and adapt to new patterns as fiber deployment changes.

Assuming detected signals resemble audio signals from electric microphones, high accuracy in interpretation can be achieved using large-scale audio pretrained models. These models, developed for environmental sound classification (ESC) and acoustic scene classification (ASC), can be fine-tuned to recognize and classify DAS-detected signals, enhancing the system's performance and reliability. Particularly, large-scale contrastive language-audio pretrained (CLAP) models [1], trained on web-based audio-caption pairs, have gained attention for their zero-shot prediction capabilities. This allows the model to generate predictions for any textual class defined by the user, offering substantial flexibility, especially when integrated with the DAS system connected with a long fiber on various environments.

However, there are challenges in applying large-scale audio pretrained models to DAS due to characteristic responses and background noise signals. These domain-specific factors cause domain shifts, leading to poor performance with pre-trained models. DAS data has different frequency responses and noise depending on fiber deployment, such as undersea cables or aerial cables, and distances from the sensing box. Fine-tuning these models is promising but requires substantial pre-recorded data, which is time-consuming, costly, or nearly impossible in some cases, especially for the underwater acoustic-event classification. Few-shot domain adaptation schemes are effective but less so when the domain shift is large, posing practical obstacles.

The rapid development of text-conditional generative models has enabled generating signals based on textual prompts, e.g., prompts such as “The sound of dog barking.” This allows users to generate synthesized audio data in various scenes. However, large-scale generative models sometimes produce irrelevant sounds due to incorrect responses (e.g., hallucinations) and nondeterministic generation processes, and need adaptation for different sensing environments, highlighting the need for innovative solutions.

### SUMMARY OF THE INVENTION

An advance in the art is made according to aspects of the present disclosure directed to two-stage domain-specific signal generation schemes using a text-conditional a generative audio model. The first stage includes an Event-classification simulator with language-audio models (e.g., CLAP models), which advantageously prevents the text-conditional generative model from generating incorrect data. The second stage incorporates a Domain shifter, which performs impulse-response convolution and background noise in addition to synthesized data, emulating unique sensing signals fiber optic sensing deployments, such as those from DAS. Advantageously, our inventive schemes can generate various synthesized data belonging to unique domains and store them as a special dataset. In terms of physical effort, our techniques only need record one impulse response and one background noise, significantly reducing data collection burden and costs typically associated with fine-tuning models. Of further advantage, our inventive schemes can be applied to other unique audio devices (e.g., laser microphones) or unique environments (e.g., underwater).

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing illustrative architectural overview of our inventive systems and methods according to aspects of the present disclosure.

FIG. 3 is a schematic diagram showing illustrative relation between user-defined target classes and corresponding datasets according to aspects of the present disclosure.

FIG. 4 is a schematic block diagram of illustrative data flows of systems and methods according to aspects of the present disclosure.

FIG. 5(A) and FIG. 5(B) are schematic diagrams showing: FIG. 5(A) text-conditional audio generation process, and FIG. 5(B) audio continuation process according to aspects of the present disclosure.

FIG. 6 is a schematic diagram showing illustrative data flows inside an event classification simulator according to aspects of the present invention.

FIG. 7 shows t-SNE plots for 50 audio events of 4 samples each with/without similarity evaluation process (CLAP filter) according to aspects of the present disclosure.

FIG. 8 is a schematic diagram showing illustrative iterative processes of audio generation, similarity evaluation, and local similarity evaluation according to aspects of the present disclosure.

FIG. 9 shows box plots illustrating loop times for one audio data generation for “water drops” and “hen” with/without continuation guide according to aspects of the present disclosure.

FIG. 10 shows a t-SNE plot of audio embedding vectors by ESC 50 dataset (Dₛ^{dry}) and generated dataset (D_{G}^{dry}) according to aspects of the present disclosure.

FIG. 11 is a schematic diagram showing an illustrative domain shift processed according to aspects of the present disclosure.

FIG. 12(A) and FIG. 12(B) are plots showing in-class/out-class cosine similarities between datasets according to aspects of the present disclosure.

FIG. 13 shows a bar chart of 50 audio classification results with different scenarios tested to recorded data by distributed acoustic sensing (DAS) according to aspects of the present disclosure.

FIG. 14 shows a feature diagram in hierarchical format according to aspects of the present disclosure.

FIG. 15 is a schematic block diagram showing an illustrative large scale acoustic recognition system according to aspects of the present disclosure.

FIG. 16 is a schematic block diagram showing an illustrative support set based acoustic recognition model according to aspects of the present disclosure.

FIG. 17 is a schematic flow diagram showing an illustrative flow for a support-set based acoustic recognition model according to aspects of the present disclosure.

FIG. 18 is a schematic flow diagram showing an illustrative flow for a “trainable” version of the support-set based acoustic recognition model according to aspects of the present disclosure.

FIG. 19 shows experimental results for full-shot classification/detection accuracies based on aspects of the present disclosure.

FIG. 20 shows experimental results for few-shot classification accuracies based on aspects of the present disclosure.

FIG. 21 shows an additional feature diagram in hierarchical format according to aspects of the present disclosure.

FIG. 22 is a schematic block diagram showing an illustrative synthetic data generation framework incorporating device/environment effects according to aspects of the present disclosure.

FIG. 23 is a schematic diagram showing an illustrative recording room and environment according to aspects of the present disclosure.

FIG. 24 is a schematic block diagram showing an illustrative pipeline of a method according to aspects of the present disclosure in which a test sample is sent to a frozen, pre-trained audio encoder to obtain the embedding, which is then used to perform cross-attenuation with the keys from the support audio samples. The attenuation weights are selected by a top-k gating layer and further multiplied by the values of the support set to serve as new knowledge. The final prediction is obtained by combining this new knowledge with zero-shot prediction from the pre-trained model according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

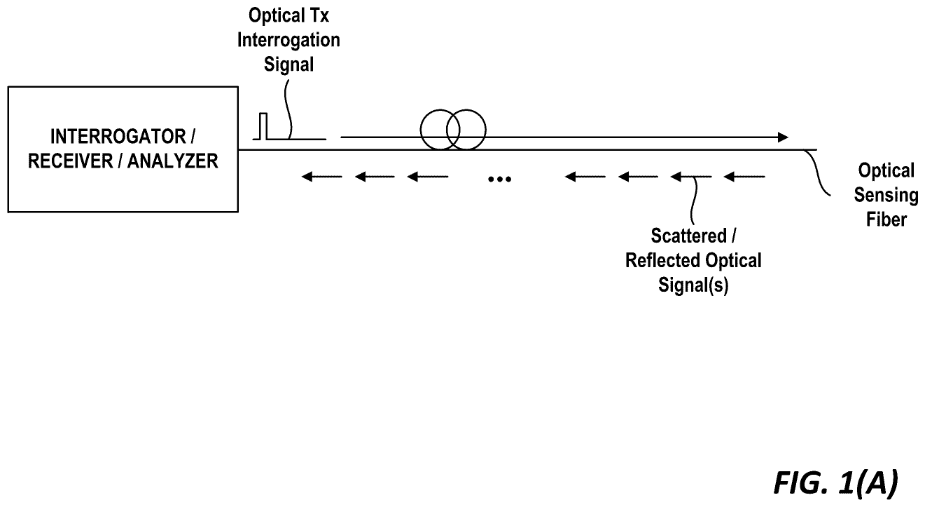

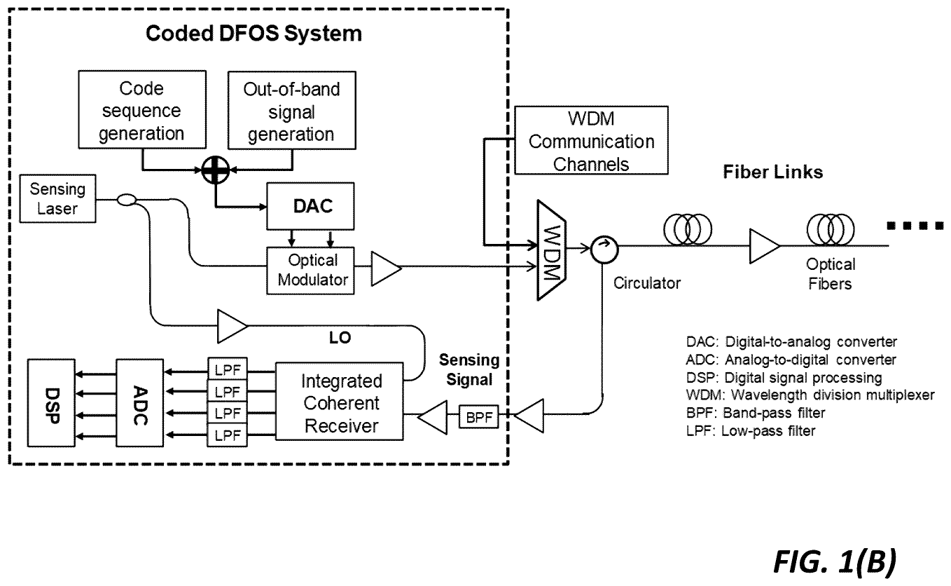

A schematic diagram illustrating the generalized arrangement and operation of a distributed fiber optic sensing system that may advantageously include artificial intelligence/machine learning (Al/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

For example, the detection of an explosion sound by our ears can immediately indicate an anomaly. Deploying numerous audio sensors, like electric microphones, over large areas can provide valuable acoustic information for anomaly detection and scene or event recognition. However, this approach is energy-intensive, and these devices may require batteries to operate.

One solution to this issue is to use a distributed fiber-optic sensor. This DFOS technology advantageously converts an optical fiber extending over 10 kilometers into a distributed sensor with a spatial resolution on the order of 1 meter. Specifically—as noted above—a sensor employing phase-sensitive optical time-domain reflectometry (Phase-sensitive OTDR), also known as a Distributed Acoustic Sensor (DAS), can convert mechanical dynamic strains on the fiber, caused by acoustic signals, into phase changes in Rayleigh backscattered light. Consequently, this allows for the monitoring of local acoustic events over very large geographic areas using the optical fiber. Of further advantage, the optical fiber may be a telecommunications-carrying optical fiber, thereby allowing telecommunications traffic and DFOS-simultaneously.

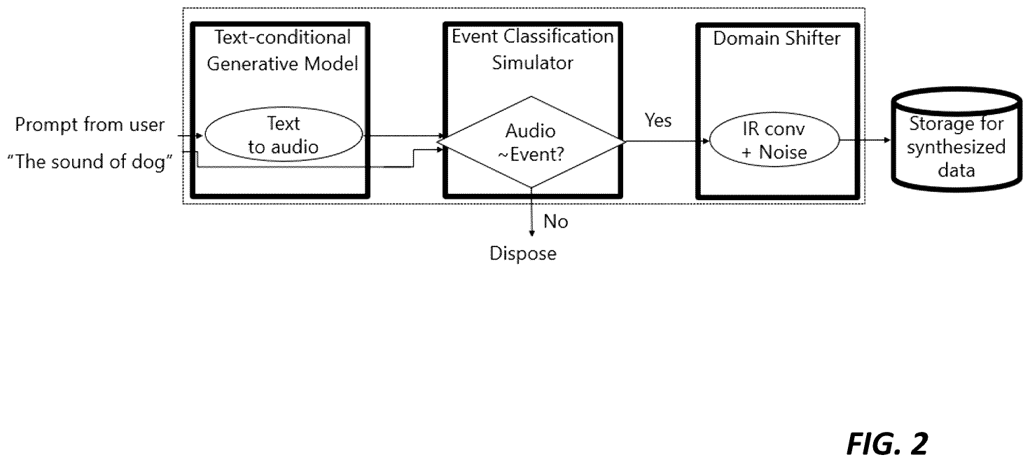

As we noted, an advance in the art is made according to aspects of the present disclosure directed to two-stage domain-specific signal generation schemes using a text-conditional a generative audio model. FIG. 2 is a schematic diagram showing illustrative architectural overview of our inventive systems and methods according to aspects of the present disclosure.

With reference to the figure, it may be observed that the first stage includes an Event-classification simulator with language-audio models (e.g., CLAP models), which advantageously prevents the text-conditional generative model from generating incorrect data. The second stage incorporates a Domain shifter, which performs impulse-response convolution and background noise in addition to synthesized data, emulating unique sensing signals fiber optic sensing deployments, such as those from DAS. Advantageously, our inventive schemes can generate various synthesized data belonging to unique domains and store them as a special dataset. In terms of physical effort, our techniques only need record one impulse response and one background noise, significantly reducing data collection burden and costs typically associated with fine-tuning models. Of further advantage, our inventive schemes can be applied to other unique audio devices (e.g., laser microphones) or unique environments (e.g., underwater).

According to aspects of the present disclosure, we create a synthesized dataset that mimics data recorded in actual environments using text conditions provided by users. This means the synthesized data should align closely with actual recorded data. Our inventive techniques (i) generate datasets effectively and efficiently that are guaranteed to be within the source domain, and (ii) transfers domains from source to target using only recorded response and noise information.

In situations where users recognize acoustic events they want to detect, they can infer events from recorded results using audio-language models; by inputting the target event labels into the language model, transforming them into embedding vectors by the language model, and comparing them with embedding vectors by the acoustic model, users can perform zero-shot inference. However, the accuracy of this inference drops due to domain shifts between the pretrained data (i.e., source domain) and the recorded data (i.e., target domain). Conversely, if users have information about response and background noise, our invention can generate synthesized datasets specific to the target domain. Once the recognition model is fine-tuned on this generated in-domain synthesized dataset, recognition accuracy will improve.

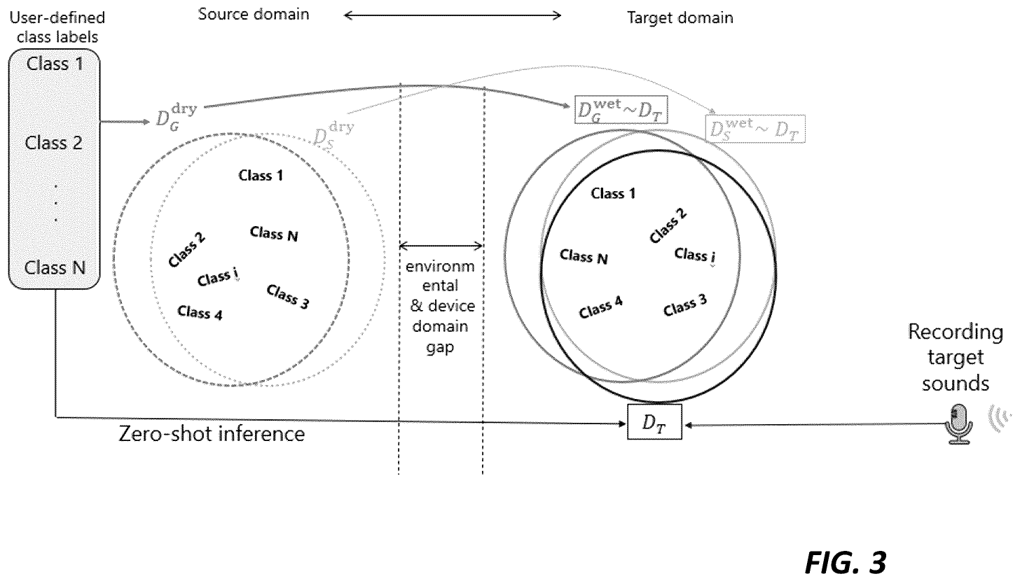

FIG. 3 is a schematic diagram showing illustrative relation between user-defined target classes and corresponding datasets according to aspects of the present disclosure. With reference to that figure, we note that when audio data is recorded in a particular environment, it is influenced by the unique characteristics of the audio devices or their deployment environments, creating domain gaps between the original dataset (dataset

$${D}_{S}^{d r y}$$

and the recorded dataset (dataset D_{T}). Using a text-conditional audio generative model, a corresponding dataset

$$\{ {D}_{G}^{d r y} )$$

can be created using only text-based labels that users target. By convolving the response and adding background noise to

$${D}_{G}^{dry} ,$$

processed dataset

$$( {D}_{G}^{w e t} )$$

will be distributed around

$${D}_{S}^{w e t} {D}_{T} , where {D}_{S}^{w e t}$$

is the convolved and noise-added version of

$${D}_{S}^{d r y} .$$

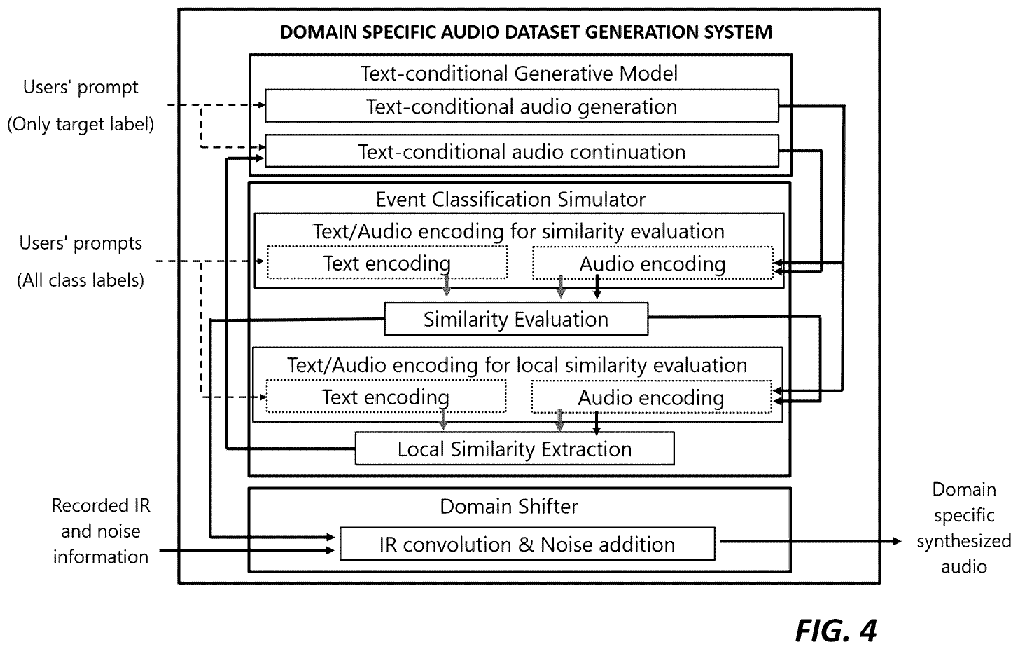

FIG. 4 is a schematic block diagram of illustrative data flows of systems and methods according to aspects of the present disclosure. As shown in the figure, where the solid arrows correspond to audio data, the broken arrows are text data, and central arrows are feature-extracted embedding vectors. Our inventive systems, methods, and structures include 3 components, i.e., (i) text-conditional audio generative model to generate audio data from users' prompts, (ii) event classification simulator to evaluate the generated synthesized audio if the audio can work as a part of high-quality datasets, and (iii) domain shifter that shift the domain of the synthesized data to the target domain by utilizing the recorded impulse response (IR) and the background noise.

In operation, users provide a prompt related to the target label they want to detect, such as “this is the sound of [target]”, where [target] is one of a class labels. The text-conditional audio generation model attempts to convert the text information into corresponding audio. The generated audio, along with the users' prompts including all the events they want to classify, is then input into the text-audio model to perform event classification by evaluating the similarity between text and audio embeddings produced by each encoder. If the generated audio is classified as the target, it is further processed by the domain shifter, which involves convolving the impulse response and adding background noise. Conversely, if the audio embedding is not sufficiently similar to the text embedding (e.g., classified as the different class other than the target), another stage evaluates the local similarities between the text prompts and audio signals extracted from the generated audio. Once the most similar part of the audio signals is identified, it is input back into the text-conditional generative model to perform the text-conditional audio-continuation task. This loop aims to create synthesized data that matches the target signals defined by the users well. If the generated data from the audio-continuation task is obtained, event classification is performed again. This loop continues until high-similarity audio data is generated

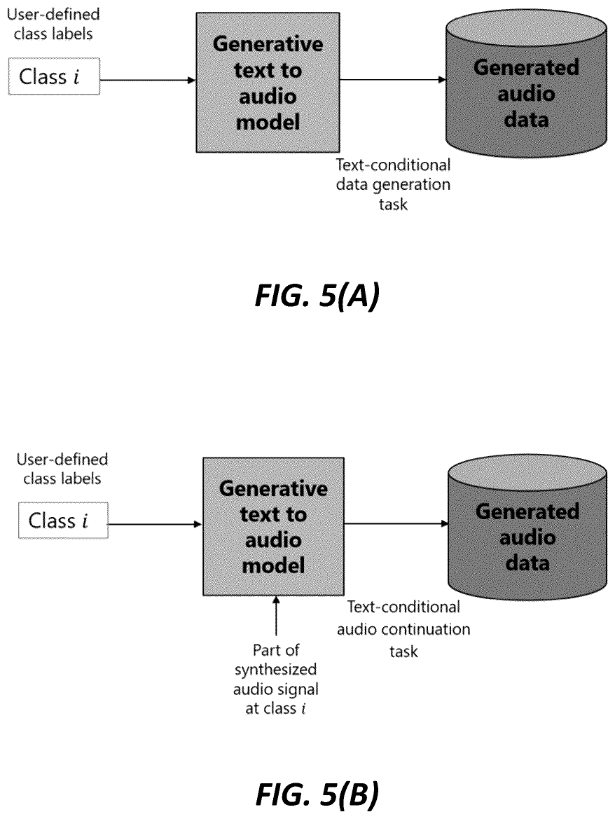

FIG. 5(A) and FIG. 5(B) are schematic diagrams showing: FIG. 5(A) text-conditional audio generation process, and FIG. 5(B) audio continuation process according to aspects of the present disclosure.

With reference to that figure, we describe the following operational steps.

Text-Conditional Audio Generative Model to Generate Audio Data from Users' Prompts

A text-conditional audio generative model generates audio data from user prompts, as described in FIG. 5(A). Although users expect the model to accurately generate data corresponding to the input class label, this process sometimes fails. This is especially common when the input class is conceptually similar to other classes, such as “Rooster” and “Hen.”

To improve the dataset, there is an additional branch that text-conditionally generates audio by referring to a part of the synthesized data (i.e., the model performs a text-conditional audio continuation task), as shown in FIG. 5(B). The quality of the generated data will be evaluated in the Event Classification Simulator in the next step. If the quality is insufficient, feedback will be provided to (b) to refine the synthesized data, as described below. There are typical generative models that incorporate both functions (a) and (b) simultaneously e.g., AudioGen or AudioLDM. In all results described herein, the AudioGen is used as the text-conditional generation model.

### Event Classification Simulator

The event classification simulator has a function to evaluate the quality of synthesized audio to determine if the data can be classified. Since the text-conditional model can generate audio based on text information with class labels, the prompt can be used for zero-shot inference with a CLAP model.

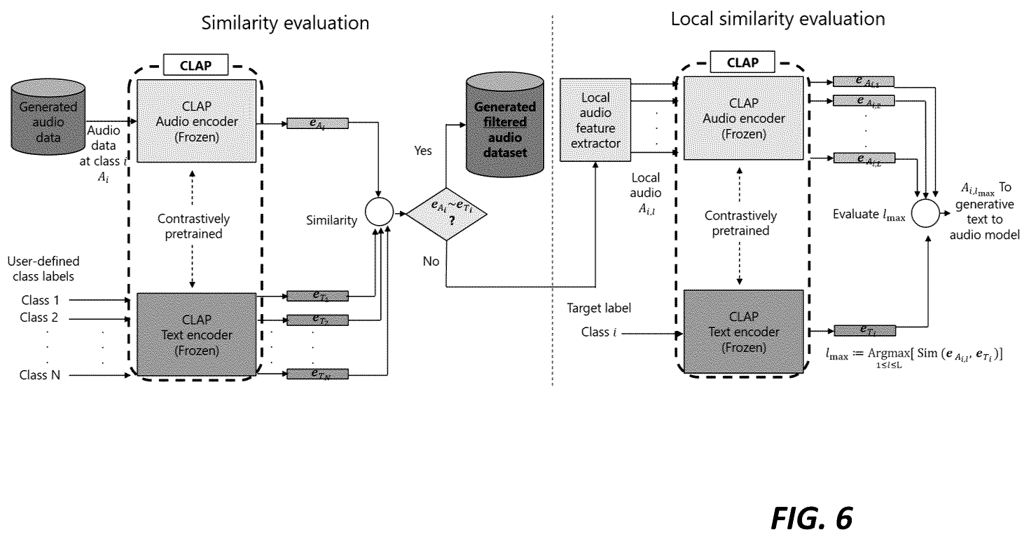

FIG. 6 is a schematic diagram showing illustrative data flows inside an event classification simulator according to aspects of the present invention.

As may be observed from this figure, it illustrates the processes within the event classification simulator. The simulator has two branches for evaluating synthesized data. Firstly, in the first branch, the synthesized data is evaluated in terms of the similarity between the audio and the target class label using the frozen CLAP model. The audio (or text) data is transformed into audio (or text) embedding vectors by the audio (or text) encoder in the CLAP model, and the similarities between the embedding vectors are assessed. One example of the similarity evaluation is to compare the target audio embedding vector with all the text embedding vectors generated by user-defined class labels, perform zero-shot inference, and evaluate if the synthesized audio is classified as the target event class. If it is classified correctly, the audio will be processed in the domain shifter. If not, the target audio will be further processed in the local similarity evaluation stage

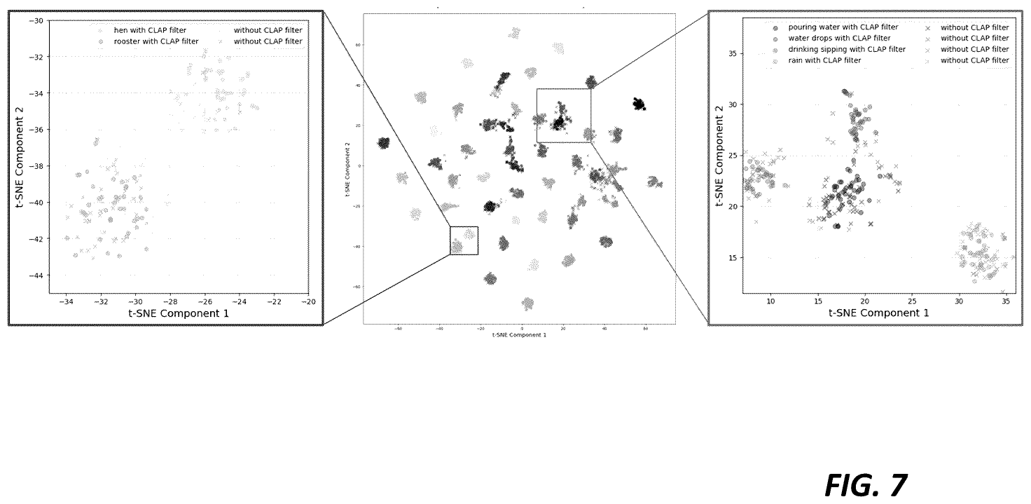

FIG. 7 shows t-SNE plots for 50 audio events of 4 samples each with/without similarity evaluation process (CLAP filter) according to aspects of the present disclosure.

Illustrated in FIG. 7 is a 2D plot of audio embedding vectors for the generated audio, both with and without event filtering (i.e., simulation of classification based on the CLAP model), created using the t-SNE algorithm. The audio dataset, which shares the same labels as the ESC50 dataset, includes 50 distinct acoustic events, with 40 samples for each event. The cross points correspond to the t-SNE plots of synthesized audio without the similarity evaluation process, showing many overlaps between events. This overlap is particularly notable for conceptually similar events, such as “Hen” and “Rooster” or “pouring water” and “water drops,” indicating that training models with this dataset alone makes classification difficult. In contrast, the circled points, which represent the results with the similarity evaluation process, exhibit clear distinctions even for conceptually similar events. This demonstrates the effectiveness of the similarity evaluation in enhancing the dataset quality in terms of acoustic event classification.

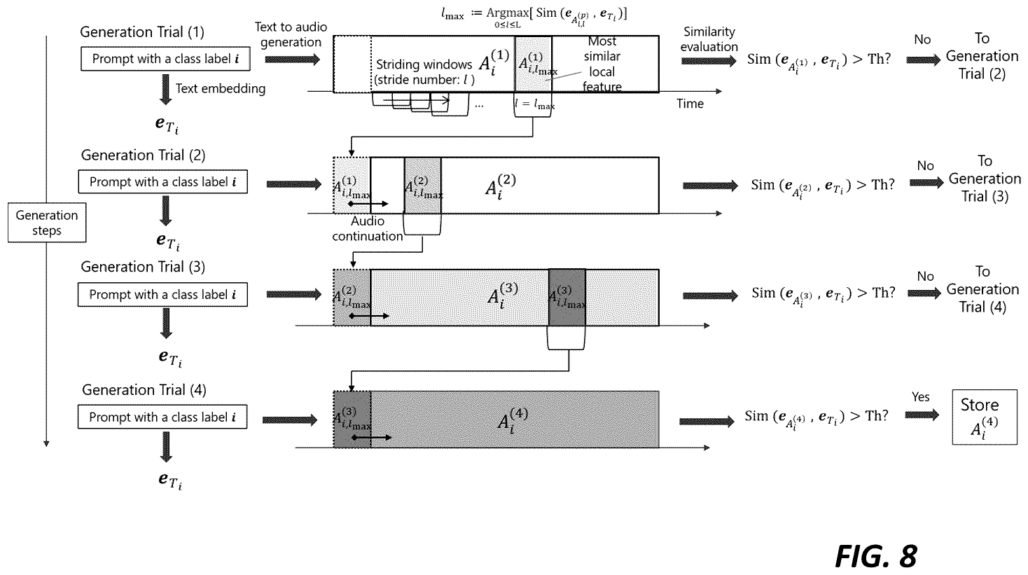

As shown in FIG. 7, generating clear audio data in a single attempt is challenging. Therefore, when event labels are conceptually similar, it takes a considerable amount of time to achieve satisfactory quality. To make this process more efficient, another branch for local similarity evaluation is introduced, as illustrated in FIG. 8, which is a schematic diagram showing illustrative iterative processes of audio generation, similarity evaluation, and local similarity evaluation according to aspects of the present disclosure.

As may be observed by inspection of FIG. 8, it describes four iterative generation steps as an example. If the first generation trial fails in terms of similarity evaluation, the process will return a part of the audio to the generative model, which then performs the audio continuation task. The section of the audio sent back to the generative model is determined by local similarity evaluation, which involves: (i) splitting the audio into segments using a time window and stride, (ii) evaluating the similarity of each segment to the target label, and (iii) identifying the segment with the highest similarity to the target label. This segment, which has the maximum local similarity to the target label, is sent back to the audio generative model. The segment with the highest local similarity is used for the audio continuation task. Thus, the text-conditional generative model will generate new audio based not only on the target text prompt but also on the audio segment similar to the target label. By iterating these processes, which we refer as “continuation guide”, the generated audio will gradually become more like the target signals

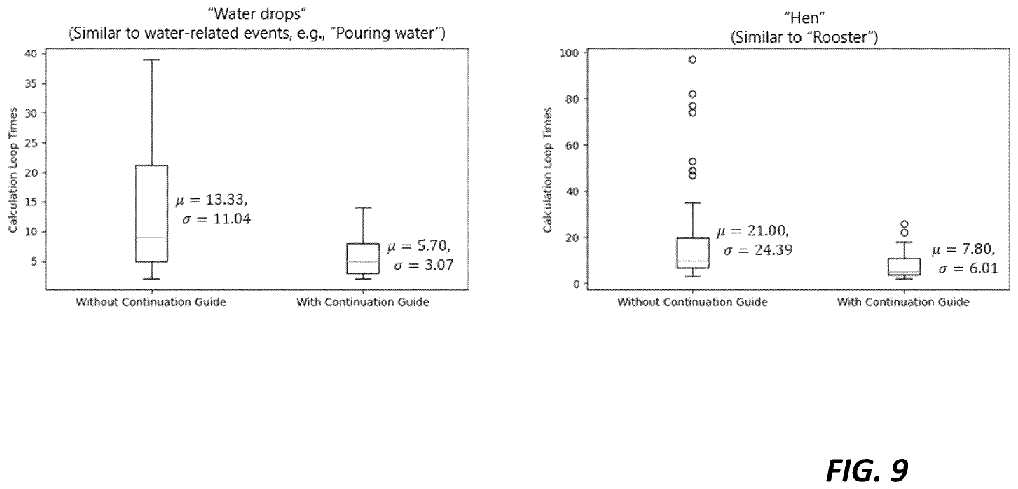

FIG. 9 shows box plots illustrating loop times for one audio data generation for “water drops” and “hen” with/without continuation guide according to aspects of the present disclosure.

Shown in the figure, are statistical box plots for the number of iterations required to generate one audio sample of “Water drops” and “Hen” events, both without and with the continuation guide. When generating audio samples with the same labels as the ESC50 dataset, these two events typically face challenges due to the similarity of sounds, such as other “water-related events” for “Water drops” and “Rooster” for “Hen.” Without the continuation guide, generating one audio sample requires an average of over 13.33 iterations for “Water drops” and 21 iterations for “Hen.” However, with the continuation guide, the average iterations are reduced to 5.7 times (a reduction of ˜42.8%) and 7.8 times (a reduction of ˜37.1%), respectively. This means that the process for generating these events becomes over twice as fast.

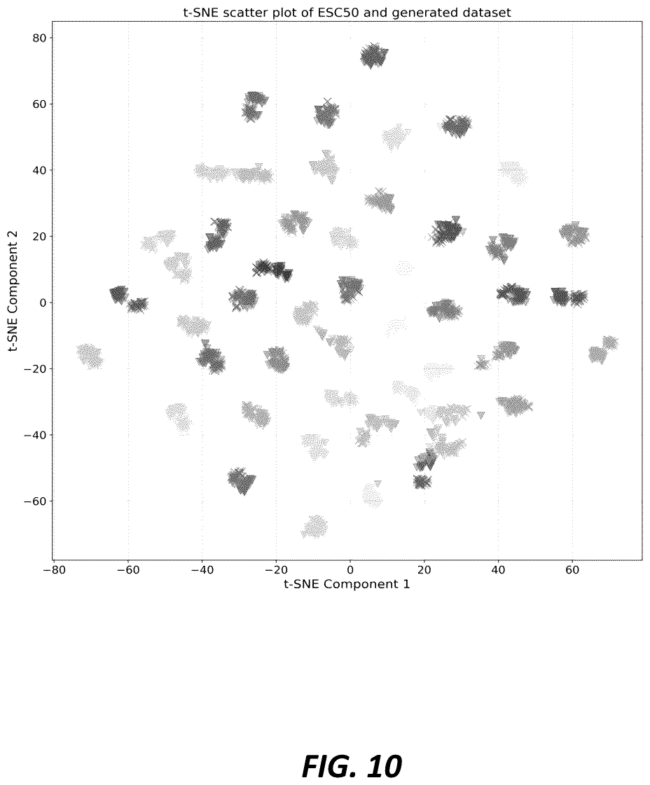

By introducing generation methods with similarity evaluation and local similarity evaluation, a high-quality dataset can be constructed. This is illustrated in FIG. 10, which presents the t-SNE 2D plot of audio embedding vectors comparing the original ESC50 dataset and the generated datasets. The figure clearly shows that the generated data by this procedure closely resembles the original recorded sounds. This similarity indicates that the generated datasets can be effectively used to fine-tune audio recognition models as a substitute for recorded sounds

However, even if we can generate sounds like the recorded data by microphones, the generated sounds are quite different from the ones recorded by special audio devices with completely different frequency responses and background noises. To make the datasets more similar to the recorded data, there is another layer to introduce these factors into the generated dataset.

### Domain Shifter

The domain shifter shifts the domain of the generated data to the target domain (i.e., recorded devices/environments) by utilizing the recorded impulse response (IR) and background noise.

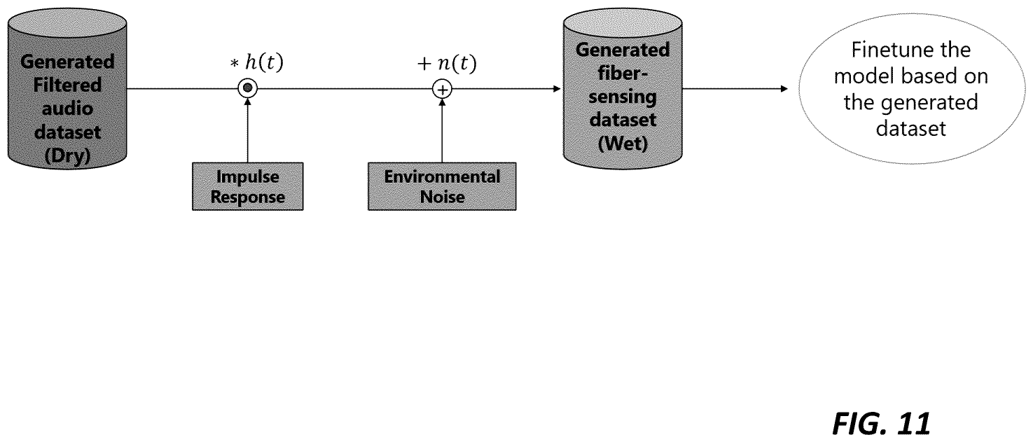

FIG. 11 is a schematic diagram showing an illustrative domain shift process according to aspects of the present disclosure.

As may be observed from FIG. 11, it briefly describes the process of shifting the domain of the generated audio datasets. We define one of the generated audio signals as s(t). The background noise n(t) and impulse response (IR) h(t) are recorded by an acoustic sensor (e.g., DAS), corresponding to the target domain. The generated target-domain signals x(t) can be obtained by adding the recorded noise and convolving the recorded impulse response with the generated dry acoustic sources, the resulting signal is given by x(t)=s(t)Ðh(t)+An(t), where A is the parameter that controls the signal-to-noise ratio. Although the domain shifter assumes recorded signals, it is also possible to apply simulated noise signals or IR to the generated signals if these characteristics are known. Additionally, well-known data augmentation schemes, such as those provided by SpecAug[5], can be applied to the generated audio data (e.g., time masking, frequency masking, time-frequency masking, and time reordering). After passing through the domain shifter, the dataset can be used for fine-tuning a specific model

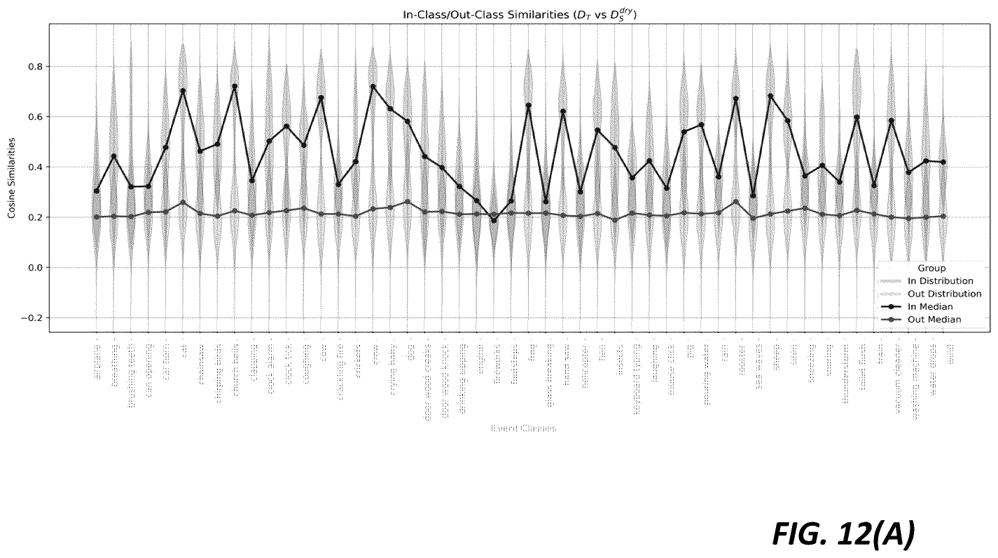

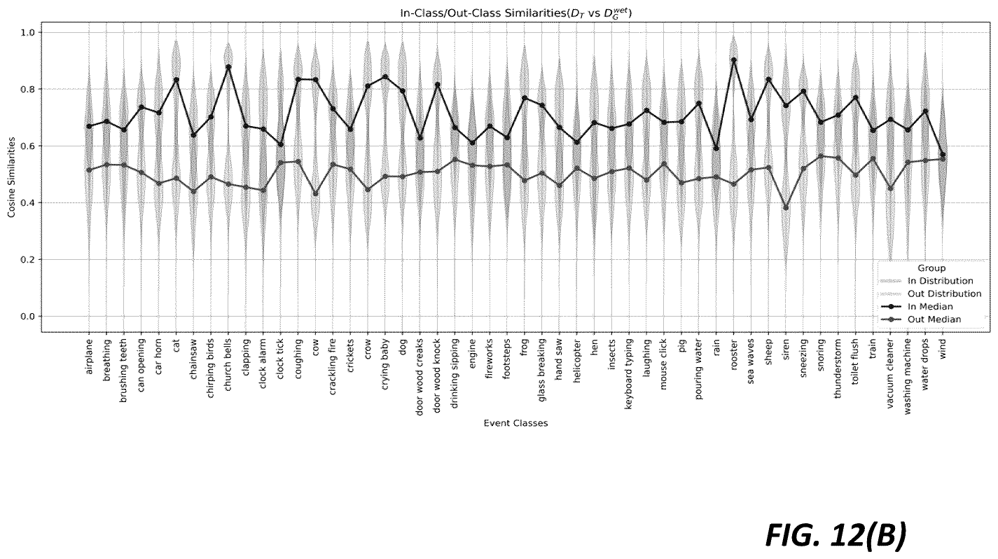

FIG. 12(A) and FIG. 12(B) are plots showing in-class/out-class cosine similarities between datasets according to aspects of the present disclosure.

As shown in these figures, are the cosine similarities of the audio embedding vectors between two datasets. The top figure compares the original ESC50 dataset

$${D}_{S}^{d r y}$$

and the recorded ESC50 dataset with a DAS D_{T}. The blue violin plots represent the distributions of cosine similarities (ranging from −1 to 1) between pairs of data within the same events, labeled as “in distribution.” The red violin plots represent the distributions of cosine similarities between pairs of data from different events, labeled as “out of distribution.” High cosine similarities within the same events and low cosine similarities between different events are favorable.

From FIG. 12(A), although in-distribution cosine similarities are high for some events, over half of the events show values lower than 0.4. This indicates that

$${D}_{S}^{d r y} and {D}_{T}$$

are not very similar to each other. These differences largely contribute to the domain shifts of the pretrained model, resulting in lower prediction accuracies. Meanwhile, FIG. 12(B), which compares the generated dataset based on our method

$${D}_{G}^{w e t} with {D}_{T} ,$$

shows higher in-distribution similarities (over 0.6 for all events except “rain” and “wind”). This means that D_{T} is more similar to

$${D}_{G}^{w e t} than to {D}_{S}^{d r y} .$$

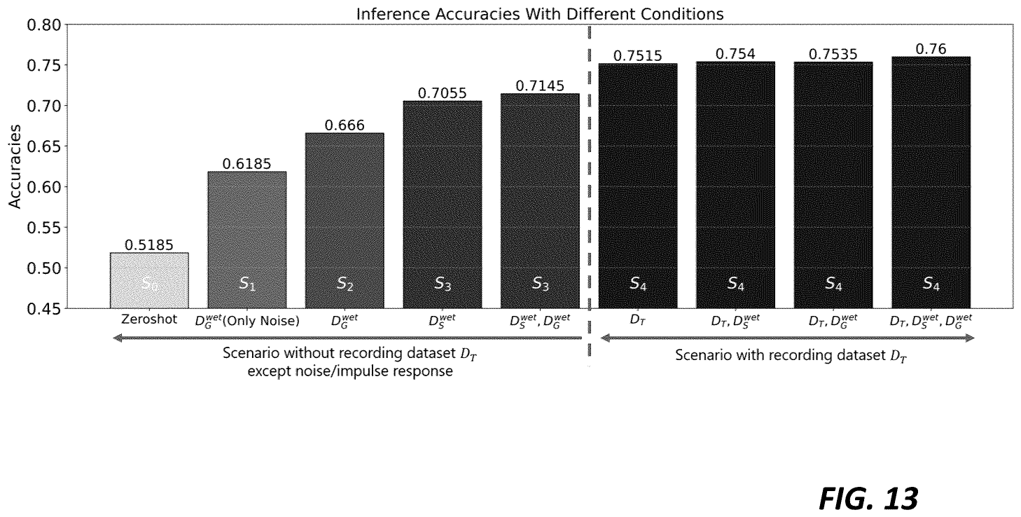

FIG. 13 shows a bar chart of 50 audio classification results with different scenarios tested to recorded data by distributed acoustic sensing (DAS) according to aspects of the present disclosure.

Shown in the figure are 5-fold audio classification results for the recorded ESC50 dataset using a fine-tuned CLAP model with various prepared datasets based on potential user scenarios. In this context, only a single linear layer is added to the audio encoder of the CLAP model, and its parameters are updated based on the datasets (Linear probe).

We consider five possible scenarios from the user's perspective:
S₀: No audio information is available for fine-tuning, corresponding to zero-shot inference with a frozen CLAP model.
S₁: With recorded background noise as a reference, it is possible to fine-tune the CLAP model using the generated signals

$${D}_{G}^{w e t}$$

by adding only the background noises.
S₂: With recorded background noise and IR information as references, it is possible to fine-tune the CLAP model using the generated signals

$${D}_{G}^{w e t} .$$

S₃: In addition to recorded background noise and IR information, some of the source data

$${D}_{S}^{d r y}$$

(real audio data included in ESC50 before recording process) and domain

$${D}_{S}^{w e t}$$

are available for fine-tuning.
S₄: Some of the recorded target-domain dataset D_{T} (recorded ESC50 data by DAS) is available, including

$${D}_{G}^{w e t} and {D}_{S}^{w e t} .$$

From scenarios S₀ to S₃, users do not need recorded data except for noise and IR data, while scenario S₄ requires recorded signals. As shown in FIG. 12, fine-tuning the model on

$${D}_{G}^{wet}$$

can improve classification accuracy by 14.75% (from S₀ to S₂) just by recording background noise and IR. Fine-tuning the model on

$${D}_{S}^{w e t} and {D}_{G}^{w e t}$$

can further improve accuracy by 19.6% (from S₀ to S₃), reaching only a 3.7% difference compared to the case with D_{T} (from S₃ to S₄). Additionally, even with the recorded dataset D_{T}, the generated datasets

$${D}_{S}^{w e t} and {D}_{G}^{w e t}$$

can serve as augmented data.

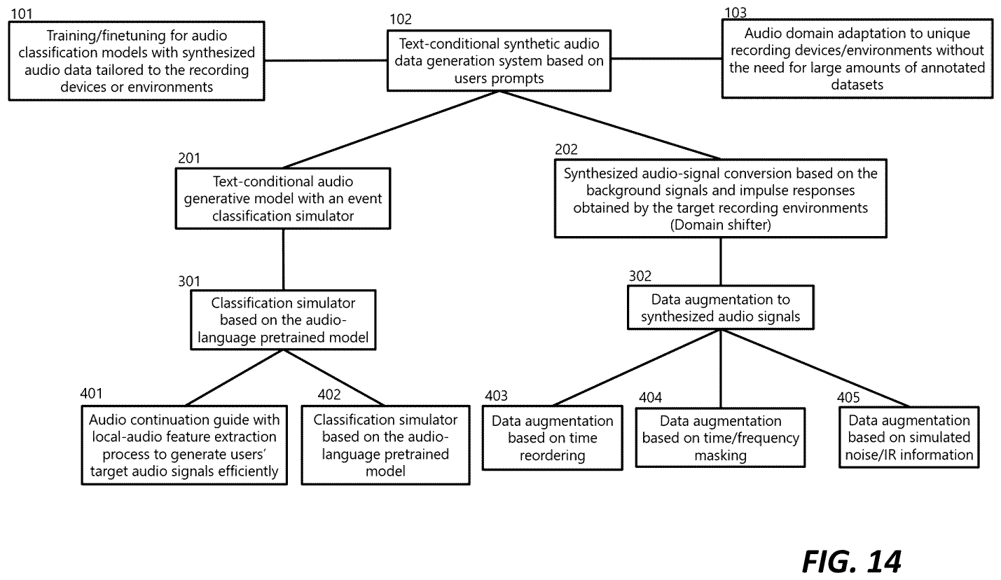

FIG. 14 shows a feature diagram in hierarchical format according to aspects of the present disclosure.

Acoustic Recognition System Efficiently Adaptable to New Environments with the Support Sets

As we have noted and will be appreciated by those skilled in the art, recognizing and analyzing diverse acoustic signals in existing distributed fiber-optic sensing systems is profoundly beneficial to many contemporary application. Additionally, we have described a large-scale acoustic recognition system based on Contrast Language-Audio Pretraining (CLAP) models. As those skilled in the art will appreciate, CLAP is a model designed to learn audio concepts from natural language supervision from large-scale audio-caption dataset. Unlike traditional audio analytics models that are typically trained with specific class labels, limiting their flexibility and requiring labeled data, CLAP models use a contrastive learning approach to connect audio and text representations. This method allows the model to map audio and text into a joint multimodal space, enabling it to generalize across multiple tasks without being constrained by predefined categories. A CLAP model excels due to its zero-shot learning capability, which allows it to predict unseen classes with great flexibility, its state-of-the-art performance across various audio tasks, and its broad generalization ability across diverse audio domains. As we have previously described, multiple acoustic signals based on optical fibers are collected, fed into an acoustic signal recognition model, and the recognition results are further analyzed and visualized for the user with a language-based interface, allowing users to input arbitrary acoustic events for classification and acoustic event/location visualization.

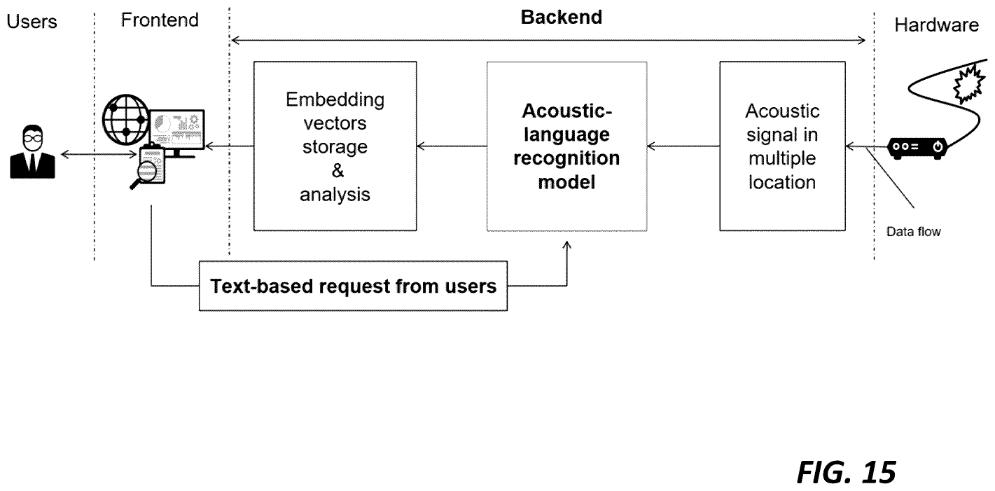

However, using a pretrained large-scale acoustic recognition system-such as that shown in FIG. 15, which is a schematic block diagram showing an illustrative large scale acoustic recognition system according to aspects of the present disclosure-pretrained on web-based audio data collected by conventional microphones is problematic, as optical fiber sensing fundamentally differs from microphones in terms of the physical principles of data acquisition. These differences result in significant variations, particularly in background noise and frequency response.

Those skilled in the art will now understand and appreciate that adapting CLAP-like audio models to our fiber optic acoustic recognition signals presents several challenges.

First, re-training the CLAP model brings large computing resource consumption. The CLAP model consists of a language encoder and an audio encoder. The language encoder is typically built using a language model like BERT or GPT-2, while the audio encoder is also based on a Transformer architecture. To adapt the model to our fiber domain, we would need to retrain the network on our fiber optic acoustic data, which would require significant computational resources. For example, training a GPT-2 Large model (762M parameters) on a dataset like OpenAI's WebText (40 GB of text) could take several days using 32 or more V100 GPUS, with costs that may exceed $100,000.

Secondly, fiber optic acoustic data is more difficult to collect and label. Unlike microphones, which can be easily deployed in various everyday scenarios, acoustic signals captured by fiber optics are much harder to obtain, especially in specialized environments like underwater fiber optics. Even if we manage to collect sufficient acoustic signals, labeling this data would require substantial human effort. This necessitates the design of adaptation methods that are data-efficient.

Finally, existing adaption method are hard to achieve an old-to-new task tradeoff. During the adaptation process, a critical issue is balancing the old and new tasks. When fine-tuning a pre-trained model, there is often a risk of the model forgetting previously learned knowledge, a phenomenon known as catastrophic forgetting. We need to develop a method that achieves a good trade-off between retaining old knowledge and adapting to new tasks in the fiber domain.

In conclusion, we describe according to the present disclosure an effective fiber optic acoustic recognition model that addresses the three technical challenges mentioned above. The designed method must be training-efficient, data-efficient, and capable of achieving a good balance between generalizing from old tasks to new ones.

Therefore, adapting acoustic sensing models trained on microphone data to different device domains, such as fiber-optic sensing, is essential

We note that when the DAS signal is fed into the audio-language model, the audio encoder converts the raw waveform into lower-dimensional embedding vectors. However, due to domain shifts from the model's pretraining on web-based audio data from electric microphones, these embeddings may shift, leading to significant accuracy degradation. Correcting this typically requires updating model weights with a large amount of annotated data, but even after fine-tuning, the model often loses much of its original knowledge

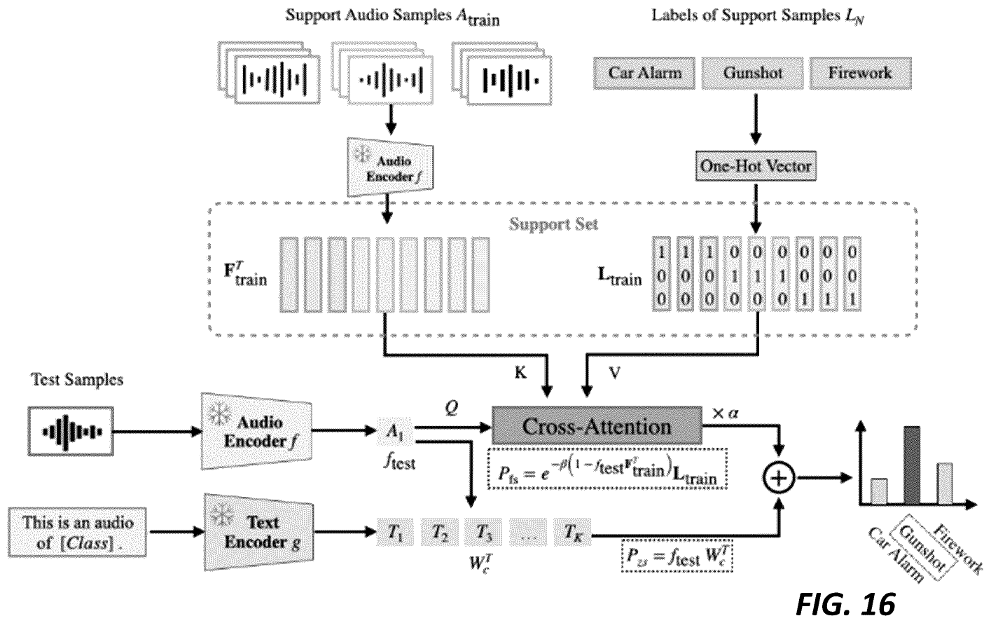

FIG. 16 is a schematic block diagram showing an illustrative support set based on an acoustic recognition model according to aspects of the present disclosure.

We now describe an invention for acoustic recognition systems based on audio-language models to address this issue. The key idea, illustrated in FIG. 16, is to integrate new knowledge from a small set of audio samples with the model's existing knowledge. The main components of this invention are: (i) a pretrained audio-language-based classifier that utilizes existing knowledge, (ii) a support set constructor that builds new knowledge from a few labeled audio samples, (iii) a cross-attention-based test audio classifier that emphasizes features common to both the pretrained and new knowledge, and (iv) a distribution combiner. Our invention enables the model to adapt to new tasks with minimal annotated data while mitigating the effects of domain shifts. Advantageously, our invention can be part of a large-scale acoustic recognition system.

As we shall show and describe, our invention contributes to solve problems described in A.1 (model-update efficiency, data efficiency, new task/domain adaptation), especially in terms of the following perspectives.

Integration of the Pre-trained Model: Our acoustic recognition model is designed based on a large-scale pre-trained model, CLAP. This means our model inherits the zero-shot recognition capabilities of the CLAP model across a wide range of acoustic signals. By adding an additional Support Set, we further enhance the CLAP model's understanding of the signals obtained by DAS. Importantly, we do this without updating the pre-trained parameters of the CLAP model, thereby preserving the pre-trained knowledge within CLAP.

Training-free design: Our goal is to establish a support set instead of updating additional models for adaptation. This approach follows a data-centric algorithm design philosophy, allowing us to easily replace the support set to quickly adapt our model to various new tasks. As a result, this method does not require parameter updates, making it training-free. By simply replacing the support set for different tasks, we also avoid updating the base model's parameters, thus preserving the pretrained knowledge of the base model.

Data Efficiency: Our method does not require a large amount of data samples to construct the support set; even with a small number of samples, sufficient additional knowledge of the new task can be provided as a reference. Experiments have shown that our method can outperform the baseline method, Adapter, even with a small number of samples. Therefore, in practical deployment, we can avoid the technical challenges of collecting and annotating large amounts of data.

Cross Attention mechanism: By applying cross attention between the test sample and the keys in the support set, we can obtain cross attention weights. These weights can further simulate the similarity between the query sample and the support samples, allowing us to retrieve the label of the support sample most similar to the test sample. This provides additional knowledge to help the model achieve better predictions.

Hyperparameter tuning: Our hyperparameters include alpha and beta. After obtaining the cross attention weights, we use the beta parameter to modulate the magnitude of the similarity between the test sample and the support samples and apply an exponential function to further convert these weights into positive influences. Additionally, we apply an alpha parameter to the pretrained knowledge, which is used to balance the contribution of the pretrained prediction probability to the final prediction probability.

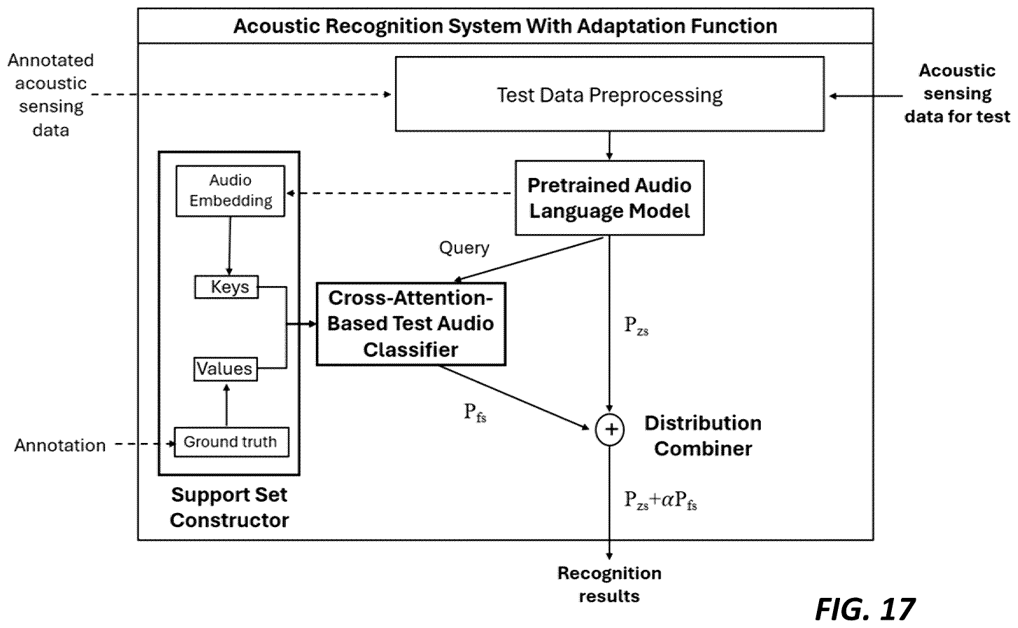

FIG. 17 is a schematic flow diagram showing an illustrative flow for a support-set based acoustic recognition model according to aspects of the present disclosure. As illustratively shown in FIG. 17, our system primarily performs the following steps: preprocessing of the test data, utilizing a large-scale pre-trained model, constructing the Support Set, and performing cross-attention between the external knowledge provided by the Support Set and the test samples to generate new knowledge. This new knowledge is then combined with the pre-trained knowledge from the model to produce the final recognition results for the acoustic signals.

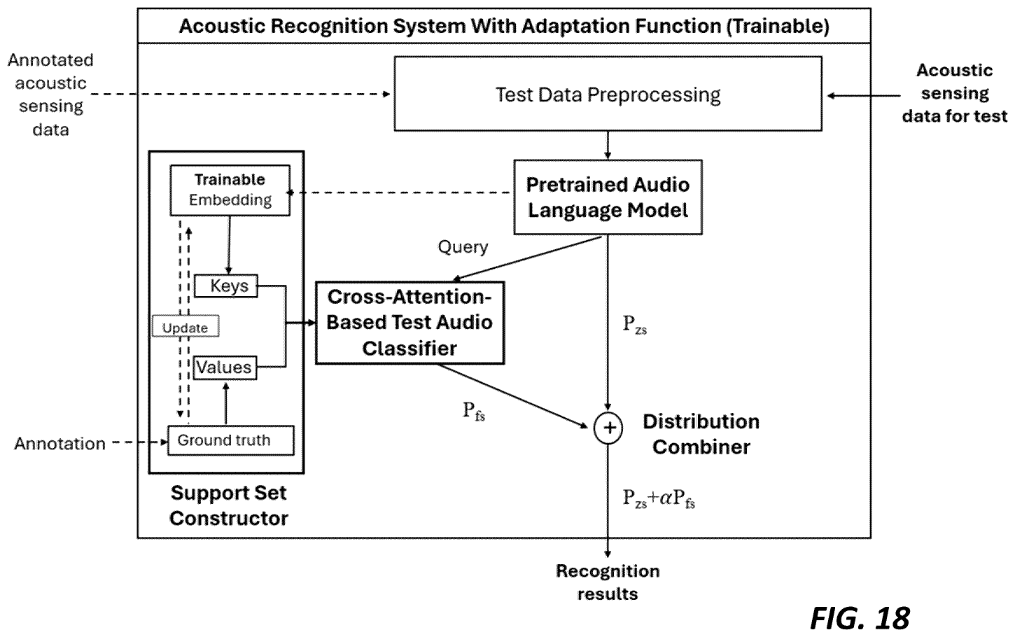

Although the current invention presumes the utilization of pretrained audio-language models, it is also possible to construct another version that includes learning function in the support set constructor, i.e., audio embedding is trainable, as shown in FIG. 18, which is a schematic flow diagram showing an illustrative flow for a “trainable” version of the support-set based acoustic recognition model according to aspects of the present disclosure.

Here is the step-by-step description of our inventive procedure includes the following.

### Sensing Data Acquisition

Collect acoustic signals, based on acoustic sensing devices such as distributed acoustic sensing technology. After obtaining sensing data, preprocess the collected fiber sensing data to adapt to the audio-language models, including steps such as resampling, conversion to log-Mel spectrogram, and etc.

### Pretrained Audio-Language-Based Classifier

In our inventive procedure, we use a pretrained audio-language model for acoustic recognition, such as CLAP. The model includes two pretrained encoders, i.e., audio and text (or language) encoders.

The preprocessed signals in the previous stage are input into the audio encoder in the model and transformed into the audio embedding vectors. At the same time, the events to classify are input into the text encoder and converted into the text embedding vectors. These audio and text embedding vectors has the same dimension in the same cross-modal latent space.

A few sets of annotated sensing data passes through the audio encoder and inputted into the support set constructor. Meanwhile, the signal to classify will be inputted int the cross-attention-based test audio classifier.

Even without the support set, we can obtain zero-shot prediction probabilities for a given category using the pre-trained model, referred to as pre-trained knowledge. By feeding all the prediction categories into the pre-trained model's text encoder and calculating the cosine similarity between the text category embeddings and the test audio sample embeddings, we could determine the predicted probability of the test audio sample belonging to a particular category. The cosine similarity between the test sample's embedding and all predefined text embeddings can be evaluated by the audio-language model, resulting P_{ZS} referred to as the probability from zero-shot pre-trained knowledge. The P_{zs} is obtained by:

$${P}_{zs} = {f}_{test} {W}_{c}^{T}$$

where fₜₑₛₜ represents the test-audio embedding vector and W_{c} is a matrix composed of all the text embedding vectors coming from classification events.

### Support Set Constructor

When adapting to a new task, we introduce the knowledge of the new task by constructing a Support Set. This Support Set includes two parts: the first part is the keys, which are the audio embeddings obtained by feeding a small number of new audio samples into the pre-trained audio encoder. The second part is the values, which are the one-hot vectors generated by converting the ground truth of these audio samples.

A few sets of annotated audio embedding datasets are stored in this stage as the keys for the support set, defined as Fₜᵣₐᵢₙ. At the same time, the corresponding labels to audio embedding, representing a new knowledge, will be transformed into one-hot representation and stored as the value expressed as Lₜᵣₐᵢₙ.

Our Support Set can be developed into two versions as distinguished in FIG. 17 and FIG. 18. The first is a Training-Free version, where the model does not require any parameter updates. In this version, we simply use the pre-trained CLAP model to extract the embeddings of the Support Audio samples, which can then be used for cross-attention with the query samples. The second is a Training-Required (trainable) version, where the embeddings of the Support Audio samples are treated as learnable and differentiable parameters. This allows us to calculate the cross-entropy loss using the learned labels and backpropagate the loss to optimize these embeddings, thereby further enhancing the model's recognition performance.

### Cross-Attention-Based Test Audio Classifier

In this module, we treat the test sample as a query sample and apply cross-attention between it and the audio samples in the Support Set. The formula for cross-attention is as follows:

$${P}_{fs} = {e}^{- β ( 1 - {f}_{test} {F}_{train}^{T} )} {L}_{train} ,$$

where β is representing temperature parameter typically given around 5.5. The obtained weights are further applied to the one-hot vectors in the Support Set to get the P_{fs} (Probability from Few Shot Support samples). In this way, our test sample effectively acquires attention in the new task. The resulting P_{fs} is referred to as the probability from few-shot new samples.

### Distribution Combiner

Finally, we combine the new knowledge P_{fs} with the pre-trained knowledge P_{ZS} to obtain our final prediction result.

$$P = {P}_{fs} + α \cdot {P}_{zs} ,$$

where α is an external parameter typically given around 1. This prediction probability was further balanced by α and combined with the new knowledge to yield the final prediction result.

The effectiveness of this invention is demonstrated as follows. Using DAS technology, two distinct acoustic datasets were constructed: one in a controlled laboratory environment, referred to as “Dataset 1,” and the other in a real-world outdoor environment, referred to as “Dataset 2.” For Dataset 1, data collection involved playing the ESC50 dataset through a loudspeaker and re-recording the sounds using a DAS system with two different fiber deployments: the “Fiber coil” (lower quality) and the “Fiber mandrel” (higher quality), in addition to recordings made with a standard electric microphone (“Microphone”). The number of samples collected matched the original ESC50 dataset, covering 50 environmental sound categories, with 40 samples per category for classification purposes. In contrast, Dataset 2, which includes real sounds captured with the outdoor fiber deployment, focused on gunshot events and other sounds not included in ESC50. This dataset was specifically designed for gunshot detection, serving entirely different purposes and tasks.

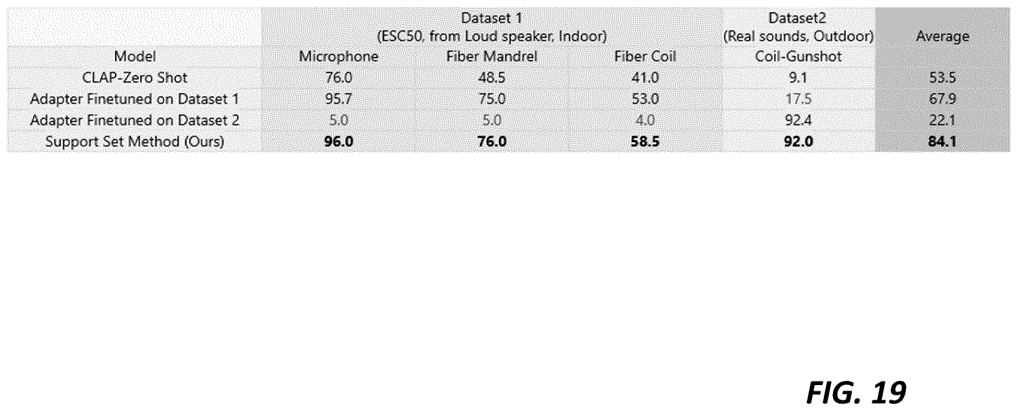

FIG. 19 shows experimental results for full-shot classification/detection accuracies based on aspects of the present disclosure.

This figure shows the results for full-shot classification/detection accuracies on Dataset 1 and Dataset 2, where the trainable version is utilized. While the conventional methods such as zero-shot and adapter-based fine tuning cannot be applied to different datasets/tasks because of overfitting (i.e., catastrophic forgetting), the method based on our invention maintains the accuracies over these datasets, i.e., well-balanced model could be constructed.

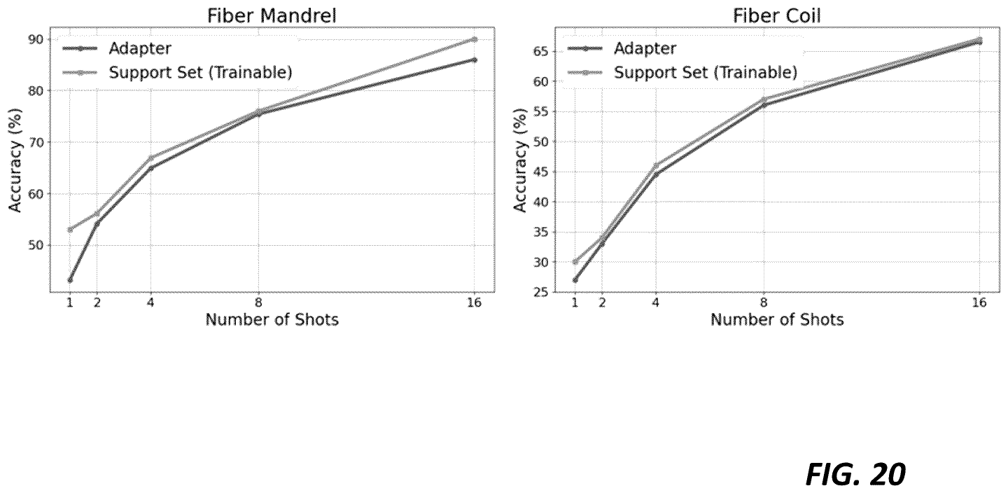

FIG. 20 shows experimental results for few-shot classification accuracies based on aspects of the present disclosure. As shown, FIG. 20 shows few-shot classification results for Dataset1, where the horizontal “number of shots” represents “learning data samples per class”, i.e., 1shot=50 audio samples. As seen in these pictures, our support-set based model outperforms the results especially fewer shots.

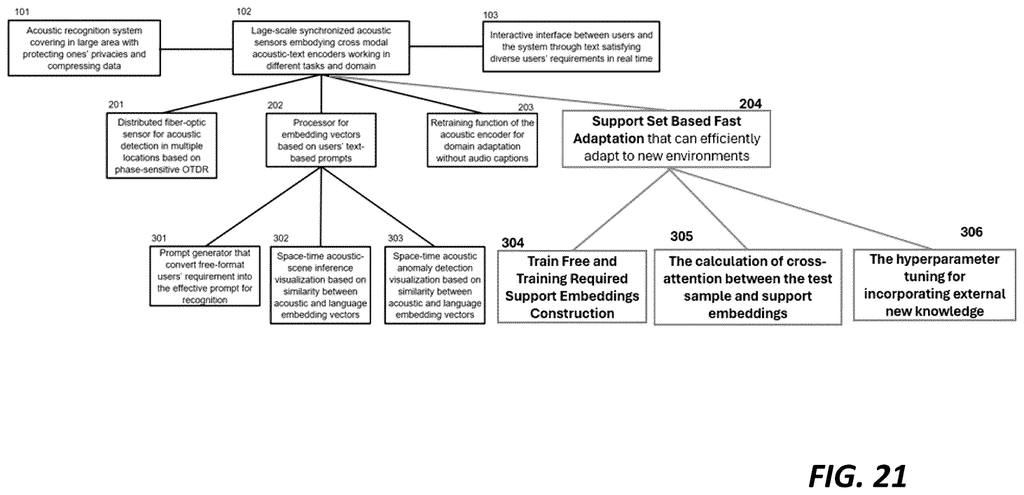

FIG. 21 shows an additional feature diagram in hierarchical format according to aspects of the present disclosure.

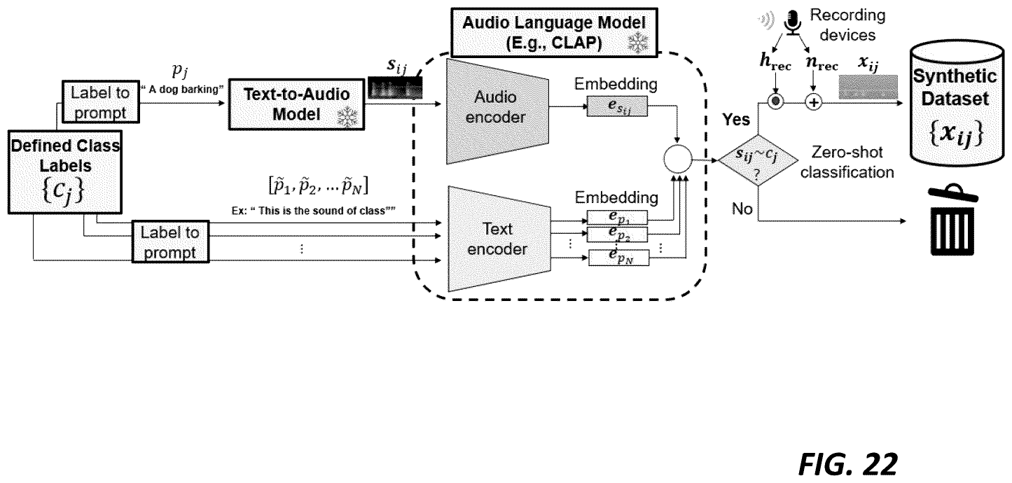

FIG. 22 is a schematic block diagram showing an illustrative synthetic data generation framework incorporating device/environment effects according to aspects of the present disclosure.

As we have noted, the generative process faces at last two issues. First the non-deterministic nature can lead to inaccurate audioclass alignment, especially for contextually or conceptually similar events such as “water drops” and “pouring water”, leading to extremely unbalanced datasets. Second, pretrained may lack domain-specific knowledge, particularly for non-conventional recording devices with varying frequency responses and background noise. Without considering these factors, updated models may produce predictions that deviate from the ground truth, such as interpreting distorted impulsive signals as “dog barking” or mistaking continuous device noise for a “vacuum cleaner,” leading to a domain shift.

To address problems above, we further process two additional steps as described in FIG. 1, (1) text-conditional data filtering for audio-event alignment and (2) domain transfer based on recorded IRs and noises.

### Text Conditional Data Filtering

Firstly, we introduce a processing to ensure alignment between the intended events and generated audio. To this end, we utilize a contrastive audio-language pretrained (CLAP) model for verifying audio-class alignment in text conditional manner. Define f_{A}(·) as the pretrained audio encoder and f_{T}(·) as the text encoder, and let eₛᵢ∈R^{d} represent the embedding of an audio sample sᵢⱼ in dimension d, and e_{p\tilde{ }j}∈R^{d} represent the text embedding associated with cⱼ, where p\tilde{ }ⱼ is the prompt corresponding to the class label cⱼ. Zero-shot prediction on sᵢⱼ is carried out by identifying the class label that maximizes the similarity between eₛᵢⱼ and the set of text embeddings

$${\{ {e}_{\tilde{{p}_{j}}} \}}_{j = 1}^{N} , as {l}_{ij =} arg {max}_{k} {e}_{sij} , {e}_{\tilde{{p}_{k}}} / \vert {e}_{sij} \vert \vert {e}_{\tilde{{p}_{k}}} \vert ,$$

and verifying if the label index for the audio embedding j matches and lᵢⱼ.

Thus, the filtered subset of the synthetic dataset is expressed as:

$${𝒟}_{𝒢} = \{ {s}_{ij} \vert {l}_{ij} = j \} \begin{matrix}N \\ j = 1\end{matrix} \begin{matrix}{\tilde{n}}_{j} \\ i = 1\end{matrix}$$

where n\tilde{ }ⱼ≤nⱼ is the number of samples for each class cⱼ after filtering. This process ensures that only samples classified correctly are retained, enhancing the dataset's reliability.

### Domain Transfer of the Synthesized Dataset

Secondly, the generated audio samples are adapted to a target recording environment. This adaptation is achieved by convolving each synthetic audio sample sᵢⱼ from the filtered dataset D_{G} with a recorded impulse response (IR) h_{rec}, which models the acoustic characteristics of the target environment, and by adding background noise n_{rec} to simulate environmental noise. The transformed sample is given by:

$$xij = hrec * sjj + α nrec ,$$

where * denotes the convolution operation and a is for controlling noise level. The resulting

$${𝒟}_{𝒢}^{dev} = \{ {x}_{i j} \} \begin{matrix}N \\ j = 1\end{matrix} \begin{matrix}{\tilde{n}}_{j} \\ i = 1\end{matrix}$$

dataset, denoted as the above, includes these adapted samples.

### Experimental Setup

In this experiment, we use a DFOS system, an acoustic sensor that employs optical fibers and operates on Phase-sensitive Optical Time-Domain Reflectometry (φ-OTDR). The system includes an optical fiber as the sensing media, a coherent laser, optical components, and a digital signal processing (DSP) unit. A pulsed laser is repeatedly sent into the fiber, and the phase of backscattered light, induced by Rayleigh scattering, is detected using a coherent detection scheme at each pulse. The DSP then evaluates phase differences between two fiber points, proportional to the dynamic strain, enabling the detection of acoustic signals interacting with the fiber.

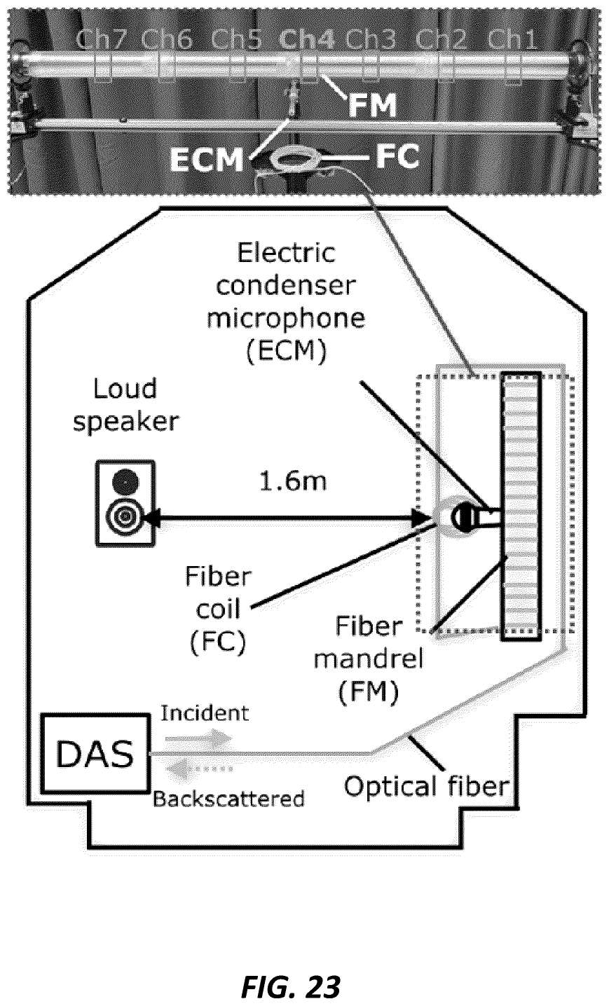

As mentioned, one major challenge is that fiber deployment changes the recorded data characteristics, e.g., the frequency response. To see this clearly, we set up a microphone (ECM8000 labeled as ECM) and two different fiber deployments: a fiber mandrel (FM) and a fiber coil (FC). FM uses a 250 μm single-mode bare fiber wrapped around a cylinder, while FC is a cable with a polyvinyl chloride jacket, as seen in the upper of FIG. 23, which is a schematic diagram showing an illustrative recording room and environment according to aspects of the present disclosure

The FM contains the fiber densely, providing numerous sensing channels with similar responses. In the recording, 7 points labeled as Ch1 to Ch7 are utilized, and Ch4 is defined as the representative FM channel. A loudspeaker is placed 1.6 meters away from these devices, as shown in the lower of FIG. 23. The IRs are constructed using 1-second linear swept sine signals with 100 synchronized summations. As plotted, the spectrograms reveal differences in frequency responses between devices. For instance, the FC showed strong attenuation above 6.5 kHz and dominant ranges such as 0.5-2.5 kHz, 2.7-3.9 kHz, and 5.2-6.3 kHz.

As a dataset, ESC-50 [21], which comprises 2000 samples of 50 environmental sounds, is utilized and recorded with ECM, FM, and FC. The audio signals are sampled at 44.1 KHz with the ECM and at 40 kHz with the FM and FC. The recorded datasets are defined as DR^{ECM}, DR^{FM}, and DR^{FC}. [Dataset generation] We utilize two models to create 5 second synthetic audio data from consistent textual prompts P (GAG), an autoregressive model, and AudioLDM2 (GLDM), a latent diffusion model. To filter the synthesized audio, we employ the CLAPMS23 model, which is composed of an HTS-AT audio encoder and a GPT-2 text encoder. For zero-shot prediction, prompts are consistently set as “this is the sound of”+C. After constructing datasets text-conditionally, recorded IRs (100 seconds recorded) and background noises (100 seconds recorded and random 5-second segments selected) are incorporated into the datasets. The noise levels were set as α=1,2 on a normalized waveform scale. We create four types of datasets for each device, including those without data filtering:

What our experiments have shown is a framework for generating synthetic audio using recorded IRs and noise. Our dataset generated following by the proposed framework improves the accuracy of acoustic event classifiers for DFOS sensing data with less recording time compared to traditional 2-shot learning. Additionally, we demonstrated that classifiers trained on the generated dataset achieve an improvement of over 8% compared to zero-shot predictions across different sensing channels in DFOS data, suggesting the IRs, noise, and generated datasets can be reused for various sensor deployments.

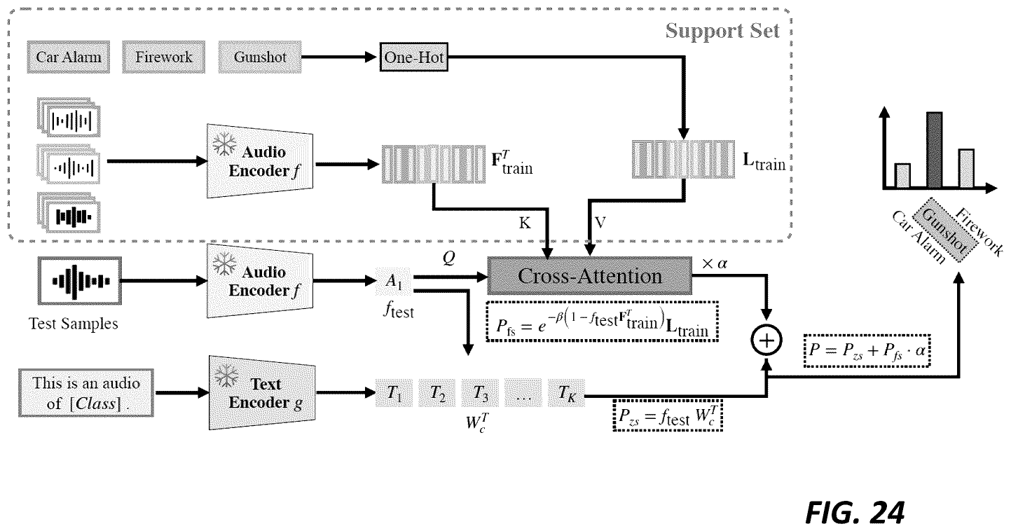

FIG. 24 is a schematic block diagram showing an illustrative pipeline of a method according to aspects of the present disclosure in which a test sample is sent to a frozen, pre-trained audio encoder to obtain the embedding, which is then used to perform cross-attenuation with the keys from the support audio samples. The attenuation weights are selected by a top-k gating layer and further multiplied by the values of the support set to serve as new knowledge. The final prediction is obtained by combining this new knowledge with zero-shot prediction from the pre-trained model according to aspects of the present disclosure.

With reference to FIG. 24, we introduce CLAP-S, a support set-based adaptation method to adapt the CLAP model to our fiber acoustic recognition task. We construct the support set from the few-shot training set in a non-parametric manner. The pipeline of our approach is illustrated in the figure. This method involves three main steps.

Construction of the Support Set: To incorporate the knowledge of a new task, we construct a support set. Given a pre-trained CLAP model and a new dataset with K-shot Nclass training samples, the training audio samples are denoted as A_{K}, and their corresponding ground truth labels as L_{N}. For each training audio sample, we use the pre-trained audio encoder of the CLAP model to extract a normalized feature vector and transform its ground truth label into an N-dimensional one-hot vector.

For all NK training samples, the audio embeddings are represented as Fₜᵣₐᵢₙ=AudioEncoder(A_{K}), where Fₜᵣₐᵢₙ∈R^{NK×C}, and the corresponding label vectors are represented as Lₜᵣₐᵢₙ=OneHot(L_{N}), where Lₜᵣₐᵢₙ∈R^{NK×N}.

This key-value mechanism effectively stores all the new information extracted from the few-shot training set.

Cross-Attention Calculation: Once the support set is constructed, the test sample is treated as a query, and crossattention is applied between it and the audio samples in the support set. The normalized feature fₜₑₛₜ∈R^{1×C} of the test sample is extracted using the CLAP model's audio encoder, which then serves as a query to the key-value model. The cross-attention weights between this query and the keys are calculated as:

$$ϕ ( x ) = {e}^{- β ( 1 - {f}_{test} {F}_{train}^{T} )}$$

Here, ß is a hyperparameter that controls the sharpness of the conversion. Since both the query and key features are normalized, the term

$${f}_{test} {F}_{train}^{T}$$

represents the cosine similarities between the test feature fₜₑₛₜ and all support training samples F_{Ttrain}.

Top-K Gating of the Support Sample: The support samples can be viewed as a mixture of experts. To enhance model capacity and reduce computational cost, we propose inserting a top-k gating layer. The Top-K gating is used to introduce sparsity, we will keep only the top k values, setting the rest to −∞ (which causes the corresponding gate values to be zero).

$$G ( x ) = Softmax ( KeepTopK ( ϕ ( x ) , k ) ) \\ {KeepTopK ( v , k )}_{i} = \{ \begin{matrix}{v}_{i} & if {v}_{i} is in the top k elements of v \\ - ∞ & otherwise .\end{matrix}$$

The gating network is trained using simple back-propagation alongside the rest of the model. When k>1, the gate values for the top k experts have non-zero derivatives concerning the gating network's weights. By applying this approach, the model can dynamically select the most pertinent experts (support samples) for each input, improving efficiency and performance.

Integrating New and Existing Knowledge Within the original CLAP model framework, we compute the cosine similarity between the embedding of a test sample and all predefined text embeddings. This yields

$${f}_{test} {W}_{c}^{T} ,$$

where W_{c} denotes the CLAP pre-trained textual embeddings. The final prediction is then obtained by combining the new knowledge P_{new} with the pre-trained knowledge P_{old}:

$${P}_{fina1} = G ( x ) {F}_{train}^{T} + α \cdot {f}_{test} {W}_{c}^{T}$$

Here, α represents the residual ratio. The main advantage of our method is that it does not require updating any parameters, effectively adapting the model to our fiber acoustic domain data in a training-free way. Additionally, the top-k gating design provides more flexibility to scale the support set to a very large size.

Trainable Support Set: Our support set can also be treated as trainable, where the support samples are viewed as learnable parameters. Specifically, we allow the support keys, Fₜᵣₐᵢₙ to be updated, while keeping the values, Lₜᵣₐᵢₙ, and the two encoders of the pre-trained CLAP model fixed. The idea is that updating the keys can improve the accuracy of the cosine similarity calculations between test and training samples, leading to better similarity estimation and finally further improving the recognition accuracy.

We now introduce the process of collecting the Fiber Acoustic Recognition dataset. Next, we conduct experiments on this dataset using the previously mentioned baseline methods and our proposed support set-based method. Finally, we apply our method to a real-world scenario.

### Datasets.

In the data collection experiment, a Distributed Fiber Optic Sensing (DFOS) system with Phase-sensitive Optical TimeDomain Reflectometry (φ-OTDR) was used to detect acoustic signals through optical fibers. The system comprises an optical fiber, a coherent laser, optical components, and a digital signal processing (DSP) unit. A microphone (ECM8000) and two fiber caused by Rayleigh scattering. The DSP unit calculated phase differences between fiber points to determine dynamic strain. A loudspeaker was placed 1.6 meters away to generate signals, and impulse responses (IRs) were constructed using 1-second linear swept sine signals with 100 synchronized summations.

### Zero-Shot & Full-Shot Adaptation

In this experiment, we manually modified the prompts of the pre-trained model to evaluate its zero-shot transfer performance on our datasets. Our experimental results have shown that adjusting the prompt can result in variations in accuracy across different groups of data. For example, changing the prompt can improve the accuracy by up to 7 percentage points on the FM dataset and by up to 5 percentage points on the FC dataset. The prompt ‘this is an audio of [class]’ achieved the best recognition accuracy on both the FM and FC datasets. Despite these findings, we observed that adjusting the prompt still has a limited effect on improving the accuracy across all four datasets. The overall recognition accuracy remains relatively low compared to the source data. The recognition accuracy for the Fiber Coil dataset is the lowest, indicating that the pre-trained model has not encountered similar data before. This also suggests that the sound quality of the Fiber Coil dataset is lower compared to the Fiber Mandrel and Microphone datasets, making it more challenging to recognize.

Based on these observations, we conducted a full-shot finetuning experiment. The results shown that fine-tuning the prompt does not significantly improve recognition accuracy. We believe the reason for this is that prompt tuning mainly aims to leverage knowledge that the pre-trained model has already learned. However, the CLAP pre-trained model has not encountered similar fiber acoustic data during its pre-training phase, making prompt adjustment insufficient. In contrast, using an adapter, which optimizes the model by adding neural network layers, significantly outperforms prompt tuning. Furthermore, our method based on the support set effectively utilizes information from the fiber data, achieving the best performance

### Multi-Device and Multi-Task Fine-Tuning

Since the ECM, FM, and FC data we recorded all come from the same audio source, they should share certain common characteristics. Therefore, when transferring models, if we combine these datasets and jointly optimize a single model, will this model perform better than those trained on individual datasets? We conducted three rounds of experiments using the Adapter method. To our surprise, the model trained jointly on all four datasets outperformed the models trained separately on each individual dataset, even though they used the same data and training duration. This result suggests that there is a positive correlation effect between these four datasets, which enhances the overall performance.

### From Laboratory Data to Real Application Case

In this experiment, we explore a more challenging problem. As we collected data from the ESC-50 environmental sound classification dataset and have trained our adapting model. However, in real-world deployment, we continually encounter new data. If we fine-tune our model on the new data, the model may completely forget the knowledge from the previous task (in this case, ESC-50). This phenomenon is known as catastrophic forgetting in machine learning. To address this issue, we propose a support set-based adaptation method that effectively balances the knowledge of both the old and new tasks simply by replacing the support set. Our experimental results demonstrate this approach.

For the new task, we selected the gunshot recognition dataset from the literature [ ]. This dataset was collected using the Fiber Mandrel and Fiber Coil deployed in real-world scenarios to capture gunshot and firework sounds, and it is considered the new task data in our setup. From the table, we observe that for traditional adapter methods, fine-tuning on the re-recorded ESC-50 data and then directly applying the model to the Fiber-gunshot and Fiber-coil datasets results in very low recognition performance, achieving only 16.9 and 9.1, respectively. Furthermore, if we continue to fine-tune the adapter on the Fiber-gunshot and Fiber-coil datasets, the model strongly forgets the knowledge from the ESC-50 re-recorded dataset, with accuracy dropping below 5.0. However, with our support set design, our method achieves a good tradeoff, allowing the model to maintain satisfactory recognition accuracy on both the old and new tasks.

### Few-Shot Adaptation on Lab Data and Real Data

To compare the adaptation performance of our method with traditional methods in few-shot scenarios, we also conducted few-shot fine-tuning experiments. The experimental results for the two tasks, Microphone and Fiber Mandrel, show that our method, outperforms the Adapter in all scenarios from 1-shot to 16-shot. For the two new tasks, Fiber-Gunshot and Coil-Gunshot, although our method slightly underperforms Adapter in the 4-shot experiment for Fiber-Gunshot and the 2-shot experiment for Coil-Gunshot, it surpasses Adapter in all other shot scenarios. More importantly, the Adapter cannot maintain high recognition accuracy on both the old task and the new task during training, whereas our method achieves a better balance between the old and new tasks by replacing the Support Set.

In this section we explored how to adapt pre-trained models for environmental sound recognition in the fiber acoustic domain. Our experiments demonstrate that the support set adaptation method significantly outperforms existing baselines in both few-shot and full-shot scenarios. Additionally, our approach showed strong performance in real-world fiber-based gunshot recognition tasks. Future research could focus on developing more robust support sets, potentially incorporating generative models to expand the support scale and further enhance our method's effectiveness.

While we have presented our inventive concepts and description using specific examples, our invention is not so limited. Accordingly, the scope of our invention should be considered in view of the following claims.

1. A system providing domain-specific signal generation using a text-conditional generative audio model, the system comprising:
the text-conditional generative model that generates audio data from user prompts;
an event classification simulator that evaluates quality of the generated audio data; and
a domain shifter that shifts a domain of the generated audio data to a target domain.

2. The system of claim 1 wherein the text-conditional generative model includes a text-conditionally generated audio by referring to a part of the audio data generated by the text-conditional generative model.

3. The system of claim 2 wherein the event classification simulator evaluates quality of the generated audio data and determines if the generated audio data can be classified.

4. The system of claim 3 wherein the generated audio data is evaluated in terms of similarity between audio and target class label using a frozen Contrastive Language-Audio Pre-Training (CLAP) model.

5. The system of claim 4 wherein the generated audio data is transformed into audio embedding vectors by an audio encoder in the CLAP model and the similarities between embedding vectors are assessed.
